(19) United States
(12) Patent Application Publication
(10) Pub. No.: US 2025/0321659 A1
(43) Pub. Date: Oct. 16, 2025

(54) ELECTRONIC DEVICE WITH TOUCH CONTROL

(71) Applicant: PIXART IMAGING INC., Hsin-Chu County (TW)

(72) Inventor: Tse-Chung SU, Hsin-Chu County (TW)

(21) Appl. No.: 19/250,070

(22) Filed: Jun. 26, 2025

Related U.S. Application Data
(63) Continuation-in-part of application No. 18/610,277, filed on Mar. 20, 2024, now Pat. No. 12,373,066.
(60) Provisional application No. 63/603,135, filed on Nov. 28, 2023.

(51) Int. Cl. G06F 3/041

(52) U.S. Cl. CPC G06F 3/041661; G06F 3/04186; G06F 2203/04104

(57) ABSTRACT

The present disclosure provides an electronic device including a touch sensing device, a control chip and a post operation system. The touch sensing device is used to output a detection signal associated with an object. The control chip is used to identify a contact area, a contact position, an operation status of the object according to the detection signal to send a corresponding report packet to the post operation system. When identifying that the contact area changes from a small area to a large area, the control chip actively sends a reset report packet to reset a current operation status to an initial contact.

### CROSS REFERENCE TO RELATED APPLICATION

The present application is a continuation-in-part application of U.S. patent application Ser. No. 18/610,277, filed on Mar. 20, 2024, which claims the priority benefit of U.S. Provisional Application Ser. Number U.S. 63/603,135, filed on Nov. 28, 2023, the disclosures of which are hereby incorporated by reference herein in their entirety.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

### BACKGROUND

### 1. Field of the Disclosure

The present disclosure generally relates to a touch control electronic device and, more particularly, to an electronic device that is able to detect a variation of touch control types to perform different touch control functions corresponding to different touch control types.

### 2. Description of the Related Art

The precision touchpad (PTP) of Microsoft Corporation may perform different control functions corresponding to whether a finger or a palm is detected thereby. For example, when the precision touchpad detects a finger, the finger may be used to control a cursor movement; whereas, when the precision touchpad detects a palm, the palm may be used to control the screen scrolling operation and the zooming operation, or the detection of a palm may be used to confirm the operation triggered by the finger.

Therefore, how to correctly determine a touch state and a state change on the precision touchpad is important so as not to induce the false operation.

The information disclosed in the Related Art herein is merely intended to increase understanding of the general background of the invention and should not be taken as an admission or in any way implied that the relevant information constitutes prior art that is already known to a person of ordinary skill in the art.

### SUMMARY

Accordingly, the present disclosure provides an electronic device that solves the problem of the post operation system not able to accept a successive operation of “Finger→Palm→Finger” on a touch pad.

The present disclosure provides an electronic device that uses a control chip to actively generate a reset report package for breaking a successive operation of “Finger→Palm→Finger” to divide the successive operation of “Finger→Palm→Finger” to two segmented operations of “Finger→Palm” and “Palm→Finger”.

The present disclosure provides an electronic device including a control chip. The control chip is used to receive a detection signal from a touch sensing device, identify a first type and a second type of an object on a sensing surface of the touch sensing device according to the detection signal, wherein the first type is a contact area of the object on the sensing surface being smaller than a first area threshold, and the second type is the contact area being larger than a second area threshold, and in response to the object changing from the first type to the second type, identify a first object leaving the sensing surface of the touch sensing device and a second object directly touching the sensing surface of the touch sensing device, wherein the object does not leave the sensing surface of the touch sensing device between changing from the first type to the second type.

The present disclosure further provides an electronic device including a control chip. The control chip is used to receive a detection signal from a touch sensing device, identify a first type and a second type of an object on a sensing surface of the touch sensing device according to the detection signal, wherein the first type is a contact area of the object on the sensing surface being smaller than a first area threshold, and the second type is the contact area being larger than a second area threshold, and in response to the object being identified as the second type for the first time, indicate a first object leaving the sensing surface of the touch sensing device and a second object directly touching the sensing surface of the touch sensing device, wherein the object does not actually leave the sensing surface upon indicating the first object leaving the sensing surface.

The present disclosure further provides an electronic device including a control chip. The control chip is used to receive a detection signal from a touch sensing device, identify a first type and a second type of at least one object on a sensing surface of the touch sensing device according to the detection signal, wherein the first type is a contact area of the object on the sensing surface being smaller than a first area threshold, and the second type is the contact area being larger than a second area threshold, generate a first report packet comprising a first object ID code, a first type code and a first tip code associated with a first object upon the first object appearing on the sensing surface, generate a second report packet comprising a second object ID code, a second type code and a second tip code associated with a second object upon the second object appearing on the sensing surface together with the first object, and report only one of the first report packet and the second report packet to a post operation system upon both the first type code and the second type code indicating the second type as well as both the first tip code and the second tip code indicating not leaving, wherein one of the first object and the second object associated with the one of the first report packet and the second report packet not being reported to the post operation system does not leave the sensing surface upon the associated report packet thereof not being reported.

### BRIEF DESCRIPTION OF THE DRAWINGS

Other objects, advantages, and novel features of the present disclosure will become more apparent from the following detailed description when taken in conjunction with the accompanying drawings.

FIG. 1A is a schematic diagram of a first operation type of an electronic device according to one embodiment of the present disclosure.

FIG. 1B is a schematic diagram of a second operation type of an electronic device according to one embodiment of the present disclosure.

FIG. 2 is a schematic diagram of a report packet of an electronic device according to one embodiment of the present disclosure.

FIG. 3A is an operational schematic diagram of an electronic device according to a first embodiment of the present disclosure.

FIG. 3B is another operational schematic diagram of an electronic device according to a first embodiment of the present disclosure.

FIG. 3C is further operational schematic diagram of an electronic device according to a first embodiment of the present disclosure.

FIG. 4A is an operational schematic diagram of an electronic device according to a second embodiment of the present disclosure.

FIG. 4B is another operational schematic diagram of an electronic device according to a second embodiment of the present disclosure.

FIG. 4C is further operational schematic diagram of an electronic device according to a second embodiment of the present disclosure.

FIG. 5 is a schematic diagram of determining an operation type according to a contact area by an electronic device according to one embodiment of the present disclosure.

FIG. 6A is a schematic diagram of an operation of two objects having different types appearing on an electronic device according to one embodiment of the present disclosure.

FIG. 6B is a schematic diagram of an operation of two objects having identical types appearing on an electronic device according to one embodiment of the present disclosure.

### DETAILED DESCRIPTION OF THE EMBODIMENT

It should be noted that, wherever possible, the same reference numbers will be used throughout the drawings to refer to the same or like parts.

One objective of the present disclosure is to provide an electronic device that resets data of a report packet when a touch type on a surface of a touch panel has a first change to cause a second change of the touch type to be treated as an initial type change so as to eliminate the problem of a successive variation of the touch type is not acceptable by an operation system of the electronic device.

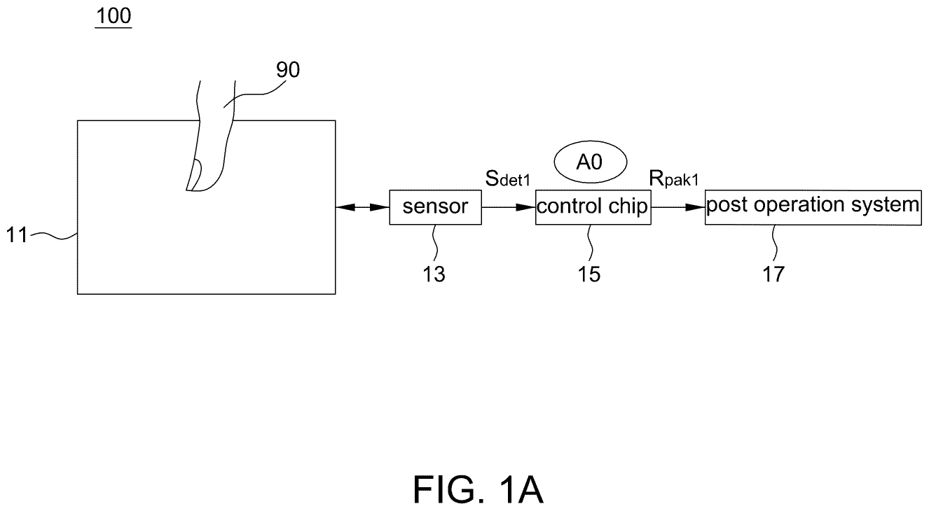

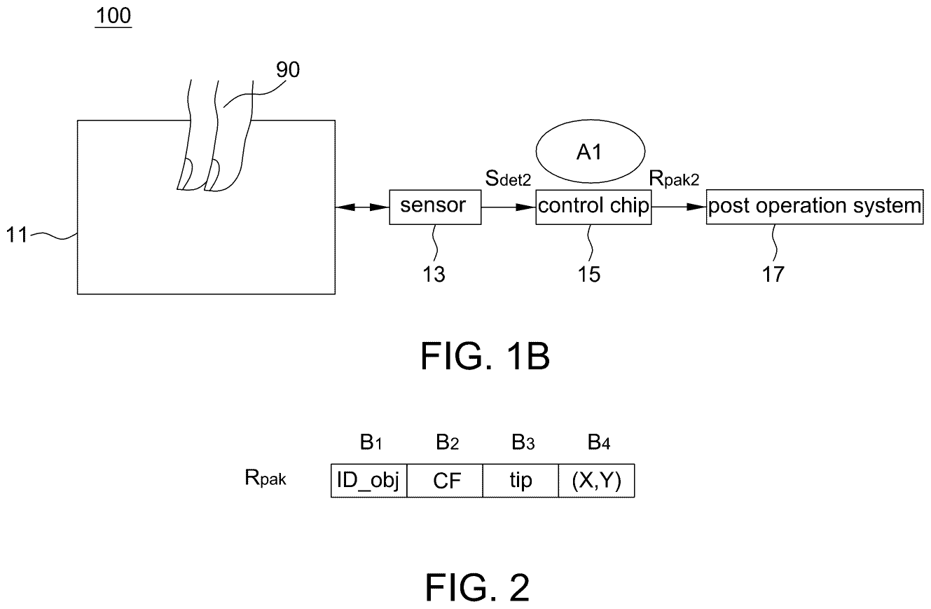

Please refer to FIGS. 1A and 1B, FIG. 1A is a schematic diagram of a first operation type of an electronic device 100 according to one embodiment of the present disclosure; and FIG. 1B is a schematic diagram of a second operation type of an electronic device 100 according to one embodiment of the present disclosure. The electronic device 100 is, for example, a notebook computer embedded with a touchpad, a tablet computer with an external touchpad or a computer device with a touch screen, but not limited thereto.

The electronic device 100 includes a touch sensing device, a control chip 15 and a post operation device 17. The touch sensing device has a sensing surface for an object 90 to perform touch controls thereon and to output a detection signal. For example, the touch sensing device includes a touchpad 11 and a sensor 13. The touchpad 11 is, for example, a capacitive touch panel, but not limited thereto. The sensor 13 is used to scan the touchpad 11 to output the detection signal (e.g., shown as S_{det1} and S_{det2}), e.g., the sensor 13 driving the touchpad 11 and detecting an operating parameter variation of the touchpad 11 (e.g., variations of charging interval or discharging interval of capacitance, voltage variations or current variations, but not limited to), and a result of the operating parameter variation is sent to the control chip 15. The method of a touch sensing device sending the detection signal is known to the art and not a main objective of the present disclosure, and thus details thereof are not described herein.

The control chip 15 has pin(s) to receive the detection signals S_{det1} and S_{det2} from the touch sensing device. The control chip 15 is, for example, embedded with software, hardware and/or firmware, to identify a contact area, an object identity (ID), a contact position, a touch type (or called operation type), and leaving or non-leaving of an object 90 on the touch sensing device according to the detection signals S_{det1} and S_{det2}, and sends, using a report rate or a report period, report packets (e.g., shown as Rₚₐₖ₁ and Rₚₐₖ₂) to the post operation system 17, e.g., a processor and an operation system of a computer device.

Please refer to FIG. 2, it is a schematic diagram of a report packet Rₚₐₖ of an electronic device 100 according to one embodiment of the present disclosure. The report packet Rₚₐₖ includes at least an object ID code (e.g., shown as ID_obj and indicated by a code B₁), a type code (e.g., shown as CF and indicated by a code B₂), a tip code (e.g., shown as tip and indicated by a code B₃), and a position coordinate (e.g., shown as X,Y and indicated by a code B₄). In the present disclosure, the codes B₁, B₂, B₃, B₄ include at least one bit, and a number of bits thereof is respectively determined according to a size of data being sent. It should be mentioned that a sequence of the codes is not limited to that shown in FIG. 2.

It is appreciated that the report packet Rₚₐₖ may include other information if required, and is not limited to those mentioned in the present disclosure.

In one aspect, the object ID code is used to indicate an object 90 appearing on a sensing surface of the touch sensing device (or of the touchpad 11). The type code CF is used to indicate a touch type (or operation type) of the object 90, e.g., a first type which is associated with a contact area A0 being smaller than a first area threshold TH1 (referring to FIGS. 1A and 5), and a second type which is associated with a contact area A1 being larger than a second area threshold TH2 (referring to FIGS. 1B and 5), wherein the second type is not limited to a palm operation, and multiple fingers of a user contacting the touchpad 11 is considered as the palm operation as long as the contact area A1 of the multiple fingers is larger than the second area threshold TH2. The tip code is used to indicate whether the object 90 leaves the sensing surface of the touchpad 11 or not. The position coordinate (X, Y) indicates a two-dimensional or one-dimensional position of the object 90 on the sensing surface of the touchpad 11. The method of the control chip 15 identifying the operating parameters (e.g., shown in FIG. 2) included in the report packet Rₚₐₖ according to the detection signals S_{det1} and S_{det2} may use conventional methods, and thus details thereof are not described herein. The present disclosure is to solve the problem of unable to perform the successive operation of “Finger→Palm→Finger” by altering the operating parameters of the report packet Rₚₐₖ.

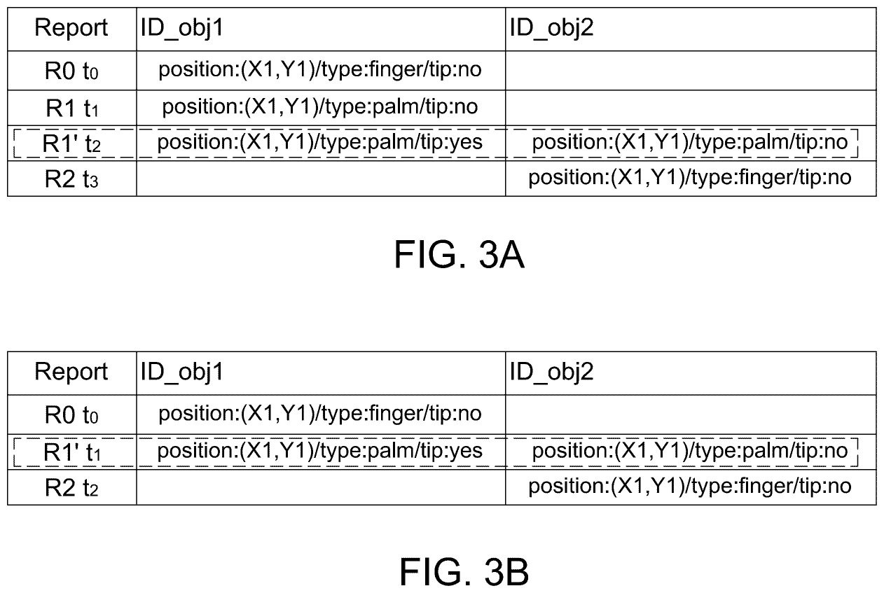

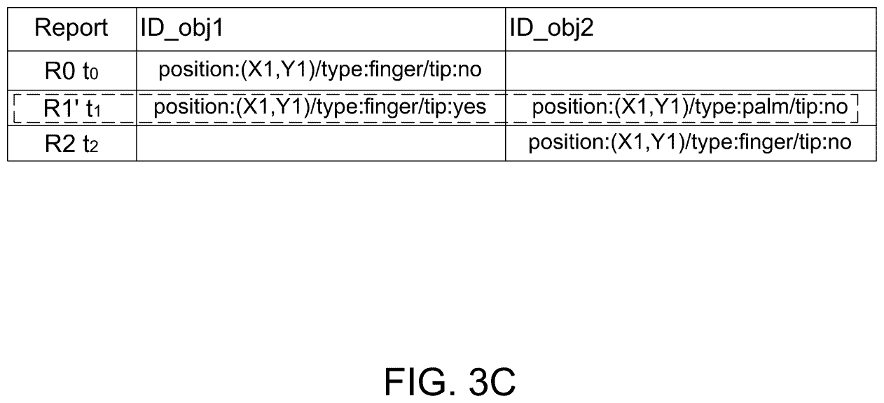

Please refer to FIGS. 3A to 3C, they are operational schematic diagrams of an electronic device 100 according to a first embodiment of the present disclosure. In the first embodiment, the control chip 15 automatically/actively sends a reset report packet in response to the object 90 changing from a first type to a second type. The reset report packet includes a first report packet and a second report packet. The first report packet includes (a first object ID code B₁, a leaving tip code B₃). The second report packet includes (a second object ID code B₁, a non-leaving tip code B₃). As mentioned above, the first type is a contact area of the object 90 being smaller than a first area threshold (e.g., A0<TH1 as shown in FIGS. 1A and 5), and the second type is the contact area of the object 90 being larger than a second area threshold (e.g., A1>TH2 as shown in FIGS. 1B and 5). Meanwhile, the object 90 does not leave (i.e. continuously in contact with) the sensing surface of the touch sensing device when the control chip 15 is sending the reset report packet.

In the first embodiment, the first area threshold TH1 is different from the second area threshold TH2 to prevent the repeatedly changing between touch types when the contact area is close to the area threshold. In another aspect, the first area threshold TH1 is set to be identical to the second area threshold TH2, i.e. using a single threshold.

In one aspect, the report packet Rₚₐₖ further includes a position coordinate (e.g., the code B₄ as shown in FIG. 2), e.g., shown as (X1,Y1), wherein the (X1, Y1) is a gravity center, a center position or a mass center of a detected object on the sensing surface according to different arrangements.

In one aspect, the report packet Rₚₐₖ further includes a type code (e.g., the code B₂ as shown in FIG. 2), e.g., shown as “finger” or “palm” in FIGS. 3A-3B.

Please refer to FIG. 3A, the control chip 15 respectively sends a report packet R0, R1, R1′ and R2 at report times t₀, t₁, t₂ and t₃.

At the report time to, the report packet R0 includes a first object ID code “ID_obj1”, a type of “finger”, a non-leaving code “no” and a position coordinate (X1,Y1) indicating that the control chip 15 detects a finger at the position coordinate (X1,Y1) on the touch sensing device.

At the report time t₁, the report packet R1 includes a first object ID code “ID_obj1”, a type of “palm”, a non-leaving code “no” and a position coordinate (X1,Y1) indicating that the control chip 15 detects a palm at the position coordinate (X1, Y1) on the touch sensing device. Now, the control chip 15 has detected a predetermined type change, i.e., from “finger” at time t₀ to “palm” at time t₁, and is ready to send a reset report packet.

At the report time t₂, the control chip 15 sends a reset report packet R1′, which includes a first report packet and a second report packet. The first report packet includes a first object ID code “ID_obj1”, a type of “palm”, a leaving code “yes” and a position coordinate (X1,Y1). The second report packet includes a second object ID code “ID_obj2”, a type of “palm”, a non-leaving code “no” and a position coordinate (X1,Y1). That is, the reset report packet R1′ indicates a first object “ID_obj1” leaving the sensing surface of the touch sensing device at a type of palm, and a second object “ID_obj2” touching the sensing surface of the touch sensing device at a type of palm, wherein the object 90 on the sensing surface of the touch sensing device is actually not leaving the sensing surface between report times t₁ and t₂.

At the report time t₃, the report packet R2 includes a second object ID code “ID_obj2”, a type of “finger”, a non-leaving code “no” and a position coordinate (X1,Y1) indicating that the control chip 15 detects a finger at the position coordinate (X1, Y1) on the touch sensing device.

In this way, a successive operation of “Finger→Palm→Finger” by the user is divided into segmented operations of “Finger→Palm” and “Palm→Finger” to be acceptable by the post operation system 17 by adding an additional reset report packet R1′.

That is, in the aspect of FIG. 3A, the control chip 15 identifies the object 90 changing from a first type (i.e. finger) to a second type (i.e. palm) at a first time t₁, and sends a reset report packet R1′ at a second time t₂, which is separated from the first time t₁ by a predetermined number of report periods.

Please refer to FIG. 3B, the control chip 15 respectively sends a report packet R0, R1′ and R2 at report times to, t₁ and t₂. The main difference between the aspects in FIG. 3B and FIG. 3A is that FIG. 3B does not include the report packet R1 shown in FIG. 3A.

Similarly, at the report time to, the report packet R0 includes a first object ID code “ID_obj1”, a type of “finger”, a non-leaving code “no” and a position coordinate (X1,Y1) indicating that the control chip 15 detects a finger at the position coordinate (X1, Y1) on the touch sensing device.

At the report time t₁, the control chip 15 detects a palm at the position coordinate (X1, Y1) on the touch sensing device. Now, the control chip 15 has detected a predetermined type change, i.e., from “finger” at time to to “palm” at time t₁, and directly sends a reset report packet R1′, which includes a first report packet and a second report packet. The first report packet includes a first object ID code “ID_obj1”, a type of “palm” (i.e. second type code), a leaving code “yes” and a position coordinate (X1,Y1). The second report packet includes a second object ID code “ID_obj2”, a type of “palm” (i.e. second type code), a non-leaving code “no” and a position coordinate (X1,Y1). That is, the reset report packet R1′ indicates a first object “ID_obj1” leaving the sensing surface of the touch sensing device at a type of palm, and a second object “ID_obj2” touching the sensing surface of the touch sensing device at a type of palm, wherein the object 90 on the sensing surface of the touch sensing device is actually not leaving the sensing surface at the report time t₁.

At the report time t₂, the report packet R2 includes a second object ID code “ID_obj2”, a type of “finger”, a non-leaving code “no” and a position coordinate (X1,Y1) indicating that the control chip 15 detects a finger at the position coordinate (X1, Y1) on the touch sensing device.

In this way, a successive operation of “Finger→Palm→Finger” by the user is divided into segmented operations of “Finger→Palm” and “Palm→Finger” to be acceptable by the post operation system 17 by adding an additional reset report packet R1′.

Please refer to FIG. 3C, the control chip 15 respectively sends a report packet R0, R1′ and R2 at report times to, t₁ and t₂. The main difference between the aspects in FIG. 3C and FIG. 3B is that FIG. 3C shows a type code B₂ in the report packet R1′ different from that in FIG. 3B.

Similarly, at the report time to, the report packet R0 includes a first object ID code “ID_obj1”, a type of “finger”, a non-leaving code “no” and a position coordinate (X1,Y1) indicating that the control chip 15 detects a finger at the position coordinate (X1, Y1) on the touch sensing device.

At the report time t₁, the control chip 15 detects a palm at the position coordinate (X1, Y1) on the touch sensing device. Now, the control chip 15 has detected a predetermined type change, i.e., from “finger” at time to to “palm” at time t₁, and directly sends a reset report packet R1′, which includes a first report packet and a second report packet. The first report packet includes a first object ID code “ID_obj1”, a type of “finger” (i.e. first type code), a leaving code “yes” and a position coordinate (X1,Y1). The second report packet includes a second object ID code “ID_obj2”, a type of “palm” (i.e. second type code), a non-leaving code “no” and a position coordinate (X1,Y1). That is, the reset report packet R1′ indicates a first object “ID_obj1” leaving the sensing surface of the touch sensing device at a type of finger, and a second object “ID_obj2” touching the sensing surface of the touch sensing device at a type of palm, wherein the object 90 on the sensing surface of the touch sensing device is actually not leaving the sensing surface at the report time t₁.

At the report time t₂, the report packet R2 includes a second object ID code “ID_obj2”, a type of “finger”, a non-leaving code “no” and a position coordinate (X1,Y1) indicating that the control chip 15 detects a finger at the position coordinate (X1, Y1) on the touch sensing device.

In this way, a successive operation of “Finger→Palm→Finger” by the user is divided into segmented operations of “Finger→Palm” and “Palm→Finger” to be acceptable by the post operation system 17 by adding an additional reset report packet R1′.

That is, in the aspects of FIGS. 3B and 3C, the control chip 15 identifies the object 90 changing from a first type (i.e. finger) to a second type (i.e. palm) at a first time t₁, and sends the reset report packet R1′ at the first time t₁.

It should be mentioned that the first embodiment is described in the way that the first object ID code “ID_obj1” and the second object ID code “ID_obj2” in the reset report packet R1′ have the same position coordinate (X1,Y1), but the present disclosure is not limited thereto. In other aspects, the control chip 15 arranges the second object ID code “ID_obj2” to have a position coordinate different from that of the first object ID code “ID_obj1”, e.g., at adjacent coordinates of (X1,Y1), but not limited thereto.

It should be mentioned that in the first embodiment, only a time interval between t₁ and t₂ in FIG. 3A is arranged as a predetermined time interval, e.g., one to three report periods. The occurrence times of other report times (e.g., to and t₃ in FIG. 3A and t₀ to t₃ in FIGS. 3B and 3C) are determined according to actual user operations.

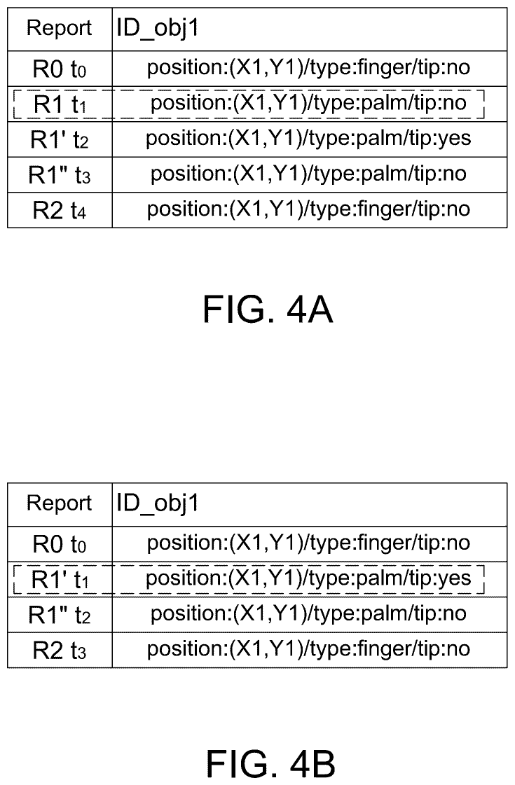

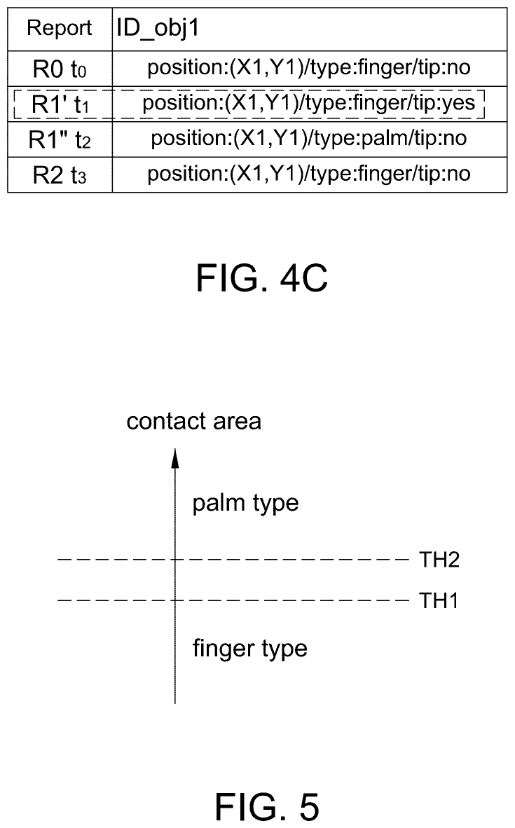

Please refer to FIGS. 4A to 4C, they are operational schematic diagrams of an electronic device 100 according to a second embodiment of the present disclosure. In the second embodiment, the control chip 15 sequentially sends a first report packet including (a first object ID code B₁, a leaving tip code B₃) and a second report packet including (a first object ID code B₁, a non-leaving code B₃) in response to the object 90 changing from a first type to a second type, i.e. the first report packet and the second report packet of the reset report packet are sent sequentially. As mentioned above, the first type is a contact area of the object 90 being smaller than a first area threshold (e.g., A0<TH1 as shown in FIGS. 1A and 5), and the second type is the contact area of the object 90 being larger than a second area threshold (e.g., A1>TH2 as shown in FIGS. 1B and 5). Meanwhile, the object 90 does not leave (i.e. continuously in contact with) the sensing surface of the touch sensing device when the control chip 15 is sending the first report packet and the second report packet.

In the second embodiment, the first area threshold TH1 is different from the second area threshold TH2 to prevent the repeatedly changing between touch types when the contact area is close to the area threshold. In another aspect, the first area threshold TH1 is set to be identical to the second area threshold TH2, i.e. using a single threshold.

In one aspect, the report packet Rₚₐₖ further includes a position coordinate (e.g., the code B₄ as shown in FIG. 2), e.g., shown as (X1,Y1), wherein the (X1, Y1) is a gravity center, a center position or a mass center of a detected object on the sensing surface according to different arrangements.

In one aspect, the report packet Rₚₐₖ further includes a type code (e.g., the code B₂ as shown in FIG. 2), e.g., shown as “finger” or “palm” in FIGS. 4A-4B.

Please refer to FIG. 4A, the control chip 15 respectively sends a report packet R0, R1, R1′, R1″ and R2 at report times to, t₁, t₂, t₃ and t₄.

At the report time to, the report packet R0 includes a first object ID code “ID_obj1”, a type of “finger”, a non-leaving code “no” and a position coordinate (X1,Y1) indicating that the control chip 15 detects a finger at the position coordinate (X1, Y1) on the touch sensing device.

At the report time t₁, the report packet R1 includes a first object ID code “ID_obj1”, a type of “palm”, a non-leaving code “no” and a position coordinate (X1,Y1) indicating that the control chip 15 detects a palm at the position coordinate (X1, Y1) on the touch sensing device. Now, the control chip 15 has detected a predetermined type change, i.e., from “finger” at time to to “palm” at time t₁, and is ready to send a reset report packet.

The main difference between the second embodiment and the first embodiment is that the reset report packet (e.g., including the first report packet R1′ and a second report packet R1″) is not accomplished at the same report time, and the object ID code “ID_obj” is not changed.

At the report time t₂, the control chip 15 sends a first report packet R1′, which includes a first object ID code “ID_obj1”, a type of “palm”, a leaving code “yes” and a position coordinate (X1,Y1). That is, the first report packet R1′ indicates a first object “ID_obj1” leaving the sensing surface of the touch sensing device at a type of palm.

At the report time t₃, the control chip 15 sends a second report packet R1″, which includes a first object ID code “ID_obj1”, a type of “palm”, a non-leaving code “no” and a position coordinate (X1,Y1). That is, the second report packet R1″ indicates a first object “ID_obj1” touching the sensing surface of the touch sensing device at a type of palm, wherein the object 90 on the sensing surface of the touch sensing device is actually not leaving between report times t₁ and t₃.

At the report time t₄, the report packet R2 includes a first object ID code “ID_obj1”, a type of “finger”, a non-leaving code “no” and a position coordinate (X1,Y1) indicating that the control chip 15 detects a finger at the position coordinate (X1,Y1) on the touch sensing device.

In this way, a successive operation of “Finger→Palm→Finger” by the user is divided into segmented operations of “Finger→Palm” and “Palm→Finger” to be acceptable by the post operation system 17 by adding an additional reset report packet R1′.

That is, in the aspect of FIG. 4A, the control chip 15 identifies the object 90 changing from a first type (i.e. finger) to a second type (i.e. palm) at a first time t₁, sends a first report packet R1′ at a second time t₂, and sends a second report packet R1″ at a third time t₃, wherein the first time t₁ and the second time t₂ as well as the second time t₂ and the third time t₃ are separated from each other by a predetermined number of report periods.

Please refer to FIG. 4B, the control chip 15 respectively sends a report packet R0, R1′, R1″, and R2 at report times to, t₁, t₂ and t₃. The main difference between the aspects in FIG. 4B and FIG. 4A is that FIG. 4B does not include the report packet R1 shown in FIG. 4A.

Similarly, at the report time to, the report packet R0 includes a first object ID code “ID_obj1”, a type of “finger”, a non-leaving code “no” and a position coordinate (X1,Y1) indicating that the control chip 15 detects a finger at the position coordinate (X1, Y1) on the touch sensing device.

At the report time t₁, the control chip 15 detects a palm at the position coordinate (X1, Y1) on the touch sensing device. Now, the control chip 15 has detected a predetermined type change, i.e., from “finger” at time to to “palm” at time t₁, and directly sends a first report packet R1′ included the in reset report packet, including a first object ID code “ID_obj1”, a type of “palm” (i.e. second type code), a leaving code “yes” and a position coordinate (X1,Y1). That is, the first report packet R1′ indicates a first object “ID_obj1” leaving the sensing surface of the touch sensing device at a type of palm.

At the report time t₂, the control chip 15 sends a second report packet R1″ included the in reset report packet, including a first object ID code “ID_obj1”, a type of “palm” (i.e. second type code), a non-leaving code “no” and a position coordinate (X1,Y1). That is, the second report packet R1″ indicates a first object “ID_obj1” touching the sensing surface of the touch sensing device at a type of palm, wherein the object 90 on the sensing surface of the touch sensing device is actually not leaving between the report times t₁ and t₂.

At the report time t₃, the report packet R2 includes a first object ID code “ID_obj1”, a type of “finger”, a non-leaving code “no” and a position coordinate (X1,Y1) indicating that the control chip 15 detects a finger at the position coordinate (X1,Y1) on the touch sensing device.

In this way, a successive operation of “Finger→Palm→Finger” by the user is divided into segmented operations of “Finger→Palm” and “Palm→Finger” to be acceptable by the post operation system 17 by adding an additional reset report packet R1′.

Please refer to FIG. 4C, the control chip 15 respectively sends a report packet R0, R1′, R1″ and R2 at report times to, t₁, t₂ and t₃. The main difference between the aspects in FIG. 4C and FIG. 4B is that FIG. 4C shows a type code B₂ in the report packet R1′ different from that in FIG. 4B.

Similarly, at the report time to, the report packet R0 includes a first object ID code “ID_obj1”, a type of “finger”, a non-leaving code “no” and a position coordinate (X1,Y1) indicating that the control chip 15 detects a finger at the position coordinate (X1, Y1) on the touch sensing device.

At the report time t₁, the control chip 15 detects a palm at the position coordinate (X1,Y1) on the touch sensing device. Now, the control chip 15 has detected a predetermined type change, i.e., from “finger” at time to to “palm” at time t₁, and directly sends a first report packet R1′ included in the reset report packet, including a first object ID code “ID_obj1”, a type of “finger” (i.e. first type code), a leaving code “yes” and a position coordinate (X1,Y1). That is, the first report packet R1′ indicates a first object “ID_obj1” leaving the sensing surface of the touch sensing device at a type of finger.

At the report time t₂, the control chip 15 sends a second report packet R1″ included in the reset report packet, including a first object ID code “ID_obj1”, a type of “palm” (i.e. second type code), a non-leaving code “no” and a position coordinate (X1, Y1). That is, the second report packet R1″ indicates a first object “ID_obj1” touching the sensing surface of the touch sensing device at a type of palm, wherein the object 90 on the sensing surface of the touch sensing device is actually not leaving between the report times t₁ and t₂.

At the report time t₃, the report packet R2 includes a first object ID code “ID_obj1”, a type of “finger”, a non-leaving code “no” and a position coordinate (X1,Y1) indicating that the control chip 15 detects a finger at the position coordinate (X1,Y1) on the touch sensing device.

In this way, a successive operation of “Finger→Palm→Finger” by the user is divided into segmented operations of “Finger→Palm” and “Palm→Finger” to be acceptable by the post operation system 17 by adding an additional reset report packet R1′.

That is, in the aspects in FIGS. 4B and 4C, the control chip 15 identifies the object 90 changing from a first type (i.e. finger) to a second type (i.e. palm) at a first time t₁, sends a first report packet R1′ at the first time t₁, and sends a second report packet R1″ at the second time t₂, wherein the first time t₁ and the second time t₂ are separated by a predetermined number of report periods.

It should be mentioned that the second embodiment is described in the way that the first report packet R1′ and the second report packet R1″ have the same position coordinate (X1,Y1), but the present disclosure is not limited thereto. In other aspects, the control chip 15 arranges the report packet R1″ to have a position coordinate different from that of the first report packet R1′, e.g., at adjacent coordinates of (X1,Y1), but not limited thereto.

It should be mentioned that in the second embodiment, only a time interval for sending the reset report packet (e.g., between t₁ and t₂ and between t₂ and t₃ in FIG. 4A and between t₁ and t₂ in FIGS. 4B and 4C) is arranged as a predetermined time interval, e.g., one to three report periods. The occurrence times of other report times are determined according to actual user operations.

As mentioned above, in the first and second embodiments of the present disclosure, the control chip 15 identifies a contact area of an object 90 on a sensing surface of the touch sensing device according to the detection signals S_{det1} and S_{det2}, and sends report packets Rₚₐₖ at a report rate. The control chip 15 automatically sends a reset report packet to reset the object 90 as an initial contact (i.e. not changing from a first type) in response to the object 90 changing from a first type (e.g., finger) to a second type (e.g., palm). The first report packet includes at least a leaving tip code (i.e. the code B₃ being a digital value indicating leaving state, e.g., “0”, but not limited to). The second report packet includes at least a non-leaving tip code (i.e. the code B₃ being a digital value indicating non-leaving state, e.g., “1”, but not limited to),

In some aspects, the first report packet further includes a first position coordinate of the sensing surface, the second report packet further includes a second position coordinate of the sensing surface, and the first position coordinate is identical to or different from the second position coordinate.

In some aspects, the first report packet further includes a first object ID code, the second report packet further includes a second object ID code, and the second object ID code is identical to or different from the first object ID code. For example, in FIGS. 3A to 3C, the second object ID code is different from the first object ID code; whereas, in FIGS. 4A to 4C, the second object ID code is identical to the first object ID code.

In some aspects, the first report packet further includes a first type code, the second report packet further includes a second type code, and the first type code is identical to or different from the second type code. For example, in FIGS. 3A to 3B and FIGS. 4A to 4B, the second type code is identical to the first type code; whereas, in FIGS. 3C and 4C, the second type code is different from the first type code.

In some aspects, the control chip 15 sends the first report packet and the second report packet at an identical report time or at different report times. For example, in FIGS. 3A to 3C, the control chip 15 sends the first report packet and the second report packet at the same report time; whereas, in FIGS. 4A to 4C, the control chip 15 sequentially sends the first report packet and the second report packet at different report times.

In some aspects, the control chip 15 identifies an object 90 changing from a first type to a second type at a first report time, and sends a first report packet at the first report time or at a report time behind the first report time. For example, in FIGS. 3B to 3C and FIGS. 4B to 4C, the control chip 15 sends a first report packet at the first report time; whereas, in FIGS. 3A and 4A, the control chip 15 sends a first report packet and a second report packet at report times behind the first report time.

In the present disclosure, the post operation system 17 performs a corresponding control according to the report packet Rₚₐₖ (e.g., referring to FIG. 2) sending from the control chip 15. For example, when the report packet Rₚₐₖ includes a code B₂ indicating a first type (e.g., finger) and a code B₃ indicating non-leaving, the post operation system 17 controls the movement of a cursor on a display screen according to the position coordinate code B₄, but not limited to; whereas, when the report packet Rₚₐₖ includes a code B₂ indicating a second type (e.g., palm) and a code B₃ indicating non-leaving, the post operation system 17 controls the screen scrolling operation and zooming operations (cursor not moving) according to the position coordinate code B₄, but not limited to. The corresponding control of the post operation system 17 according to the report packet Rₚₐₖ is previously embedded in the post operation system 17 according to different requirements.

In a further aspect, as long as the control chip 15 identifies, for the first time, the object 90 on a sensing surface of a touchpad 11 has a second type (including the object 90 being identified as the first type before being identified as the second type, and no object on the sensing surface of a touchpad 11 being identified before the object 90 is identified as the second type), the control chip 15 automatically sends a reset report packet indicating that the object 90 leaves the sensing surface and a second object having the second type touches (non-leaving) the sensing surface, e.g., referring to the report packet R1′ shown in FIGS. 3A and 3B and the report packet R1′ and R1″ shown in FIGS. 4A and 4B.

That is, the present disclosure is not limited to that the first type must be identified previous to the second type.

In one aspect, the second object is the same object as the object 90, i.e. the object 90 actually not leaving the sensing surface when the control chip 15 indicates leaving status. In one aspect, an object ID of the object 90 before and after being identified as the second type for the first time is changed (e.g., referring to FIGS. 3A and 3B) or not changed (e.g., referring to FIGS. 4A and 4B). The definitions of the first type and the second type have been described above, and thus details thereof are not repeated herein.

The present disclosure further provides an electronic device that automatically ignores one of two objects having the second type and does not report to the post operation system 17 so as to increase performance of the post operation system 17. It is noticed that when multiple report packets associated with palms are sent to the operation system 17, the performance of the operation system 17 is degraded.

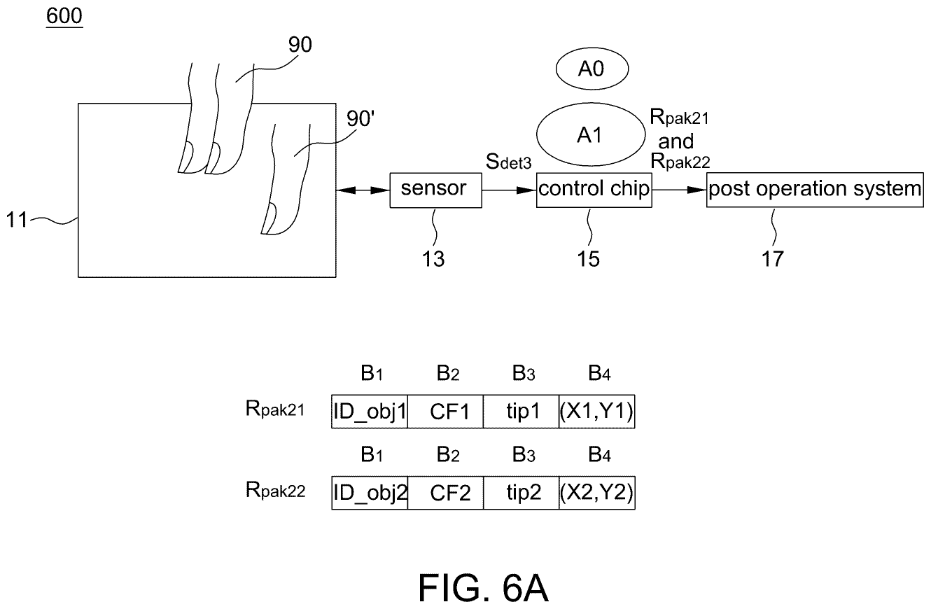

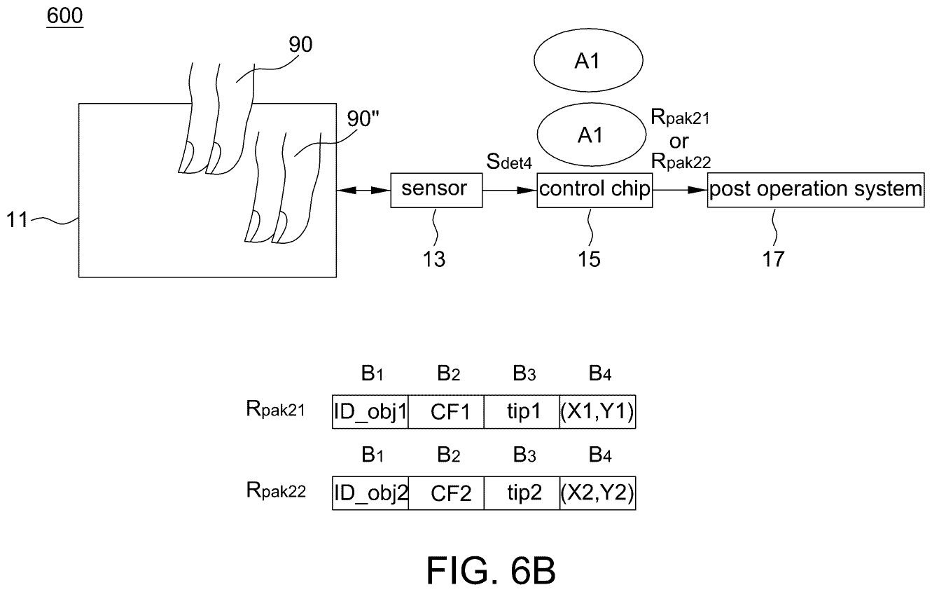

Please refer to FIG. 6A, it is a schematic diagram of an operation of two objects 90 and 90′ having different types appearing on an electronic device 600 according to one embodiment of the present disclosure.

As mentioned above, the sensor 13 scans the touchpad 11 to output a detection signal S_{det3}; and the control chip 15 receives the detection signal S_{det3} from the touchpad 11, and identifies a first type and a second type of at least one object (e.g., shown as two objects 90 and 90′) on a sensing surface of the touchpad 11 according to the detection signal S_{det3}. As mentioned above, the first type is a contact area of the object (e.g., shown as A0) on the sensing surface being smaller than a first area threshold, and the second type is the contact area of the object (e.g., shown as A1) being larger than a second area threshold.

The control chip 15 generates a first report packet Rₚₐₖ₂₁ including a first object ID code (e.g., shown as ID_obj1), a first type code (e.g., shown as CF1), a first tip code (e.g., shown as tip1) and/or a first position code (e.g., shown as (X1, Y1)) associated with a first object 90 upon the first object 90 appearing on the sensing surface, and generates a second report packet Rₚₐₖ₂₂ including a second object ID code (e.g., shown as ID_obj2), a second type code (e.g., shown as CF2) a second tip code (e.g., shown as tip2) and/or a second position code (e.g., shown as (X2, Y2)) associated with a second object 90′ upon the second object 90′ appearing on the sensing surface together with the first object 90. Details of every code of the first report packet Rₚₐₖ₂₁ and the second report packet Rₚₐₖ₂₂ have been described above and thus are not repeated herein.

In this embodiment, the control chip 15 reports both of the first report packet Rₚₐₖ₂₁ and the second report packet Rₚₐₖ₂₂ to the post operation system upon 17 upon both the first tip code tip1 and the second tip code tip2 indicating not leaving as well as one of the first type code CF1 and the second type code CF2 indicating the first type and the other one of the first type code CF1 and the second type code CF2 indicating the second type, e.g., finger object 90′ and palm object 90. In this aspect, the control chip 15 may send a report packed of the palm object 90 in the way as described above in FIGS. 3A-3C and 4A-4C to divide successive operations of “Finger→Palm→Finger” into two segmented operations of “Finger→Palm” and “Palm→Finger”.

Please refer to FIG. 6B, it is a schematic diagram of an operation of two objects 90 and 90″ having identical types appearing on an electronic device 600 according to one embodiment of the present disclosure. As mentioned above, the sensor 13 scans the touchpad 11 to output a detection signal S_{det4}; and the control chip 15 receives the detection signal S_{det4} from the touchpad 11, and identifies a first type and a second type of at least one object (e.g., shown as two objects 90 and 90″) on a sensing surface of the touchpad 11 according to the detection signal S_{det4}.

When both the first type code CF1 and the second type code CF2 indicate the second type, i.e. two palms 90 and 90″, as well as both the first tip code tip1 and the second tip code tip2 indicate not leaving, the control chip 15 reports only one of the first report packet Rₚₐₖ₂₁ and the second report packet Rₚₐₖ₂₂ to the post operation system upon 17, wherein one of the first object 90 and the second object 90″ associated with the one of the first report packet Rₚₐₖ₂₁ and the second report packet Rₚₐₖ₂₂ not being reported to the post operation system 17 does not leave the sensing surface upon the associated report packet thereof not being reported.

For example, after the first report packet Rₚₐₖ₂₁ and the second report packet Rₚₐₖ₂₂ are generated, they are initially recorded in registers of the electronic device 600. If the first object 90 and the second object 90″ start to appear on the sensing surface at the same time, the control chip 15 selects (e.g., according to positions or sizes or historical operations, but not limited thereto) one of the first object 90 and the second object 90″ to be ignored, and the report packet (e.g., Rₚₐₖ₂₂) associated with the ignored object (e.g., 90″) is not reported to the post operation system 17, but the report packet (e.g., Rₚₐₖ₂₁) associated with the non-ignored object (e.g., 90) is reported to the post operation system 17. If the first object 90 and the second object 90″ start to appear on the sensing surface at a time difference, the control chip 15 may ignore the object appearing on the sensing surface later, but not limited to.

As for the non-ignored palm object (e.g., 90, but not limited to), the control chip 15 may send the report packed thereof (e.g., Rₚₐₖ₂₁) in the way as described above in FIGS. 3A-3C and 4A-4C to divide successive operations of “Finger→Palm→Finger” into two segmented operations of “Finger→Palm” and “Palm→Finger”.

When there are two finger objects (i.e. first type) appearing on the sensing surface of the electronic device 600 at the same time, the two finger objects are recognized as two separated objects, and report packets of the two separated objects are both sent to the post operation system 17. The control chip 15 of the present disclosure considers a scenario regarding a palm or two palms appearing on a sensing surface of the touchpad 11, and the two palms are not limited to start to appear on the sensing surface at the same time.

It should be mentioned that although the FIGS. 6A and 6B use two objects as an example, it is only intended to illustrate but not to limit the present disclosure. When there are multiple palms (more than two) appearing on the sensing surface of the touchpad 11, the control chip 15 reports the report packet associated only one of the multiple palms and ignores other report packets.

It should be mentioned that although the drawings of the present disclosure show the finger operation and the palm operation respectively using a single finger and two fingers as examples, the present disclosure is not limited thereto. Any object may be used as the object 90 of the present disclosure as long as the object is detectable by the touch sensing device of the present disclosure.

It should be mentioned that although the drawings of the present disclosure show the touch sensing device by a touchpad 11 as an example, the present disclosure is not limited thereto. In another aspect, the touch sensing device of the present disclosure is combined to a display screen to form a touch sensor display.

As mentioned above, because the precision touchpad of Microsoft Corporation currently cannot accept a successive operation of “Finger→Palm→Finger”, a user may need to repeatedly take off and put on his/her palm during operating the precision touchpad. Accordingly, the present disclosure further provides an electronic device that automatically resets an operating status as firstly leaving and then touching again (e.g., FIGS. 3A-3C and 4A-4C) that may prevent a type change of “Finger→Palm” from unintentionally occurring to cause the operation of “Palm→Finger” to be unacceptable. In this way, the user needs not to frequently take off an operating object (e.g., palm) from a sensing surface to effectively improve the user experience.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. An electronic device, comprising:
a control chip, configured to
receive a detection signal from a touch sensing device,
identify a first type and a second type of an object on a sensing surface of the touch sensing device according to the detection signal, wherein the first type is a contact area of the object on the sensing surface being smaller than a first area threshold, and the second type is the contact area being larger than a second area threshold, and
in response to the object changing from the first type to the second type, identify a first object leaving the sensing surface of the touch sensing device and a second object directly touching the sensing surface of the touch sensing device,
wherein the object does not leave the sensing surface of the touch sensing device between changing from the first type to the second type.

2. The electronic device as claimed in claim 1, wherein the first object has the second type and the second object has the second type. (FIGS. 3A-3B and 4A-4B)

3. The electronic device as claimed in claim 2, wherein the control chip is configured to
send a first report packet indicating the first object leaving the sensing surface,
send a second report packet indicating the second object directly touching sensing surface, and
the first report packet and the second report packet are sent at a same report time. (FIGS. 3A-3B)

4. The electronic device as claimed in claim 2, wherein the control chip is configured to
send a first report packet indicating the first object leaving the sensing surface,
send a second report packet indicating the second object directly touching sensing surface, and
the first report packet and the second report packet are sent at different report times. (FIGS. 4A-4B)

5. The electronic device as claimed in claim 1, wherein the first object has the first type and the second object has the second type. (FIGS. 3C and 4C)

6. The electronic device as claimed in claim 5, wherein the control chip is configured to
send a first report packet indicating the first object leaving the sensing surface,
send a second report packet indicating the second object directly touching sensing surface, and
the first report packet and the second report packet are sent at a same report time. (FIG. 3C)

7. The electronic device as claimed in claim 5, wherein the control chip is configured to
send a first report packet indicating the first object leaving the sensing surface,
send a second report packet indicating the second object directly touching sensing surface, and
the first report packet and the second report packet are sent at different report times. (FIG. 4C)

8. The electronic device as claimed in claim 1, wherein the first object and the second object have a same object ID code. (FIGS. 4A-4C)

9. The electronic device as claimed in claim 1, wherein the first object and the second object have different ID codes. (FIGS. 3A-3C)

10. The electronic device as claimed in claim 1, wherein the control chip is configured to send one reset report packet to indicate the first object leaving the sensing surface and the second object directly touching sensing surface. (FIGS. 3A-3C)

11. The electronic device as claimed in claim 10, wherein a report time of sending the one reset report packet is identical to a time of detecting the object changing from the first type to the second type. (FIGS. 3B-3C)

12. The electronic device as claimed in claim 10, wherein a report time of sending the one report packet is later than a time of detecting the object changing from the first type to the second type. (FIG. 3A)

13. The electronic device as claimed in claim 1, wherein the control chip is configured to send two successive report packets to indicate the first object leaving the sensing surface and the second object directly touching sensing surface. (FIGS. 4A-4C)

14. The electronic device as claimed in claim 13, wherein a report time of sending a first of the two successive reset report packets is identical to a time of detecting the object changing from the first type to the second type. (FIGS. 4B-4C)

15. The electronic device as claimed in claim 13, wherein a report time of sending a first of the two successive reset report packets is later than a time of detecting the object changing from the first type to the second type. (FIGS. 4B-4C)

16. The electronic device as claimed in claim 1, wherein the second area threshold is larger than the first area threshold.

17. An electronic device, comprising:
a control chip, configured to
receive a detection signal from a touch sensing device,
identify a first type and a second type of an object on a sensing surface of the touch sensing device according to the detection signal, wherein the first type is a contact area of the object on the sensing surface being smaller than a first area threshold, and the second type is the contact area being larger than a second area threshold, and
in response to the object being identified as the second type for the first time, indicate a first object leaving the sensing surface of the touch sensing device and a second object directly touching the sensing surface of the touch sensing device,
wherein the object does not actually leave the sensing surface upon indicating the first object leaving the sensing surface.

18. The electronic device as claimed in claim 17, wherein
the first object has the first type or the second type, and
the second object has the second type.

19. An electronic device, comprising:
a control chip, configured to
receive a detection signal from a touch sensing device,
identify a first type and a second type of at least one object on a sensing surface of the touch sensing device according to the detection signal, wherein the first type is a contact area of the object on the sensing surface being smaller than a first area threshold, and the second type is the contact area being larger than a second area threshold,
generate a first report packet comprising a first object ID code, a first type code and a first tip code associated with a first object upon the first object appearing on the sensing surface,
generate a second report packet comprising a second object ID code, a second type code and a second tip code associated with a second object upon the second object appearing on the sensing surface together with the first object, and
report only one of the first report packet and the second report packet to a post operation system upon both the first type code and the second type code indicating the second type as well as both the first tip code and the second tip code indicating not leaving,
wherein one of the first object and the second object associated with the one of the first report packet and the second report packet not being reported to the post operation system does not leave the sensing surface upon the associated report packet thereof not being reported.

20. The electronic device as claimed in claim 19, wherein the control chip is further configured to
report both of the first report packet and the second report packet to the post operation system upon both the first tip code and the second tip code indicating not leaving as well as one of the first type code and the second type code indicating the first type but the other one of the first type code and the second type code indicating the second type.
